(19) United States
(12) Patent Application Publication
(10) Pub. No.: US 2018/0196582 A1
(43) Pub. Date: Jul. 12, 2018

(54) METHOD AND ELECTRONIC DEVICE FOR MANAGING DATA ITEMS

(71) Applicant: Samsung Electronics Co., Ltd., Suwon-si (KR)

(72) Inventors: Kaushik DAS, Kolkata (IN); Joy BOSE, New Delhi (IN)

(21) Appl. No.: 15/866,979

(22) Filed: Jan. 10, 2018

(30) Foreign Application Priority Data
Jan. 11, 2017 (IN) 201741001225

(51) Int. Cl. G06F 3/0481; G06F 3/0488; G06F 3/0484

(52) U.S. Cl. CPC G06F 3/04815; G06F 3/0484; G06F 3/04812; G06F 3/0488

(57) ABSTRACT

An electronic device is provided that includes a display comprising a touch screen, the display including a main display portion and at least one edge display portion, and at least one processor configured to control the display to display a content on the main display portion, determine at least one graphical user interface (GUI) element in associated with the content to be rendered on the at least one edge display portion, and control the display to display the at least one GUI element on the at least one edge display portion, wherein the at least one GUI element is displayed at a depth level.

### CROSS-REFERENCE TO RELATED APPLICATION(S)

This application claims the benefit under 35 U.S.C. § 119(a) of an Indian patent application filed on Jan. 11, 2017 in the Indian Intellectual Property Office and assigned Serial number 201741001225, the entire disclosure of which is hereby incorporated by reference.

### TECHNICAL FIELD

The present disclosure relates to electronic devices. More particularly, the present disclosure relates to a method and electronic device for managing data items.

### BACKGROUND

Generally, current applications on electronic devices fitted with a display panel provide a two dimensional (2D) display interface. Even though three dimensional (3D) interfaces are much more intuitive, the few existing 3D interfaces, like in a task switcher or games, are not assisted by the form factor of the device display, i.e., they just appear as 3D animations on a 2D surface.

With the advent of the curved displays such as in edge devices, the animations on the devices can leverage the curvature of the display to give the users a 3D look and feel that is more coherent and realistic.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and electronic device thereof for managing data items.

Another aspect of the present disclosure is to provide a method for determining, by at least one processor, at least one graphical user interface (GUI) element to be rendered on an edge portion of the electronic device.

Another aspect of the present disclosure is to provide a method for causing, by the at least one processor, to display a graphical data representation comprising the at least one GUI element on the edge portion of the electronic device, where the at least one GUI element is displayed at a depth level.

Yet another aspect of the present disclosure is to provide a method for determining, by the at least one processor, a plurality of GUI elements of an application to be rendered on an edge portion of the electronic device.

Yet another aspect of the present disclosure herein is to provide a method for causing, by the at least one processor, to display a graphical data representation including the plurality of GUI elements of the application on the edge portion of the electronic device, where the plurality of GUI elements are displayed at a depth level.

In accordance with an aspect of the present disclosure, a method for managing data items by an electronic device is provided. The method includes determining, by at least one processor, at least one GUI element to be rendered on an edge portion of the electronic device. Further, the method includes causing, by the at least one processor, to display a graphical data representation including the at least one GUI element on the edge portion of the electronic device, where the at least one GUI element is displayed at a depth level.

In an embodiment, a shadow of the at least one GUI element is displayed on the edge portion of the electronic device.

In an embodiment, the shadow of the at least one GUI element includes an indicia indicating information about the corresponding GUI element.

In an embodiment, the at least one GUI element is rendered on the edge portion of the electronic device along with an active GUI.

In an embodiment, the at least one GUI element is displayed at the depth level below the active GUI.

In an embodiment, the at least one GUI element is associated with at least one application and the active GUI is associated with at least one application.

In an embodiment, the method includes detecting, by the at least one processor, an input performed by a user on the edge portion of the electronic device. Further, the method includes performing, by the at least one processor, an action to display at least one portion of the at least one GUI element on a screen of the electronic device.

In an embodiment, the at least one portion of the at least one GUI element is displayed by transitioning the at least one GUI element.

In an embodiment, each of the GUI elements includes an indicia indicating information about the corresponding GUI element.

In an embodiment, the GUI element of the application is one of a sub-GUI of the application, a sub-GUI of a state of the application, and a sub-GUI of a page of the application.

In an embodiment, the graphical data representation is a three dimensional (3D) graphical data representation associated with the depth level.

In accordance with another aspect of the present disclosure, a method for managing data items by an electronic device is provided. The method includes determining, by at least one processor, a plurality of GUI elements of an application to be rendered on an edge portion of the electronic device. Further, the method includes causing, by the at least one processor, to display a graphical data representation including the plurality of GUI elements of the application on the edge portion of the electronic device, where the plurality of GUI elements is displayed at a depth level.

In an embodiment, a shadow of the plurality of GUI elements is displayed on the edge portion of the electronic device.

In an embodiment, the shadow of the plurality of GUI elements comprises an indicator indicating information about the corresponding GUI element.

In an embodiment, the method further includes detecting, by the at least one processor, an input performed by a user on the edge portion of the electronic device. Further, the method includes detecting, by the at least one processor, a level of resistance applied on the edge portion of the electronic device based on the input performed by the user. Further, the method includes automatically, by the at least one processor, flipping a number of GUI elements from the plurality of GUI elements based on the level of resistance.

In an embodiment, the number of GUI elements is automatically flipped to display a GUI element available in the plurality of GUI elements after flipping the number of GUI elements.

In an embodiment, the plurality of GUI elements is rendered along with an active GUI.

In an embodiment, the plurality of GUI elements is displayed at a depth level below the active GUI.

In an embodiment, each of the GUI elements of an application is one of a GUI of the application, a sub-GUI of a state of the application, and a sub-GUI of a page of the application.

In accordance with another aspect of the present disclosure, an electronic device for managing data items is provided. The electronic device includes a memory, at least one processor, coupled to the memory, and at least one processor configured to determine at least one GUI element to be rendered on an edge portion of the electronic device. Further, the at least one processor is configured to control to display a graphical data representation including the at least one GUI element on the edge portion of the electronic device, where the at least one GUI element is displayed at a depth level.

In accordance with another aspect of the present disclosure, an electronic device for managing data items is provided. The electronic device includes a memory, at least one processor, coupled to the memory, and a at least one processor configured to determine a plurality of GUI elements of an application to be rendered on an edge portion of the electronic device. Further, the at least one processor is configured to control to display a graphical data representation comprising the plurality of GUI elements of the application on the edge portion of the electronic device, where the plurality of GUI elements are displayed at a depth level.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIGS. 1A, 1B, and 1C illustrate example scenarios in which a graphical representation including content pages (i.e., graphical user interface (GUI) elements) of a news application are displayed on an edge portion of an electronic device (i.e., Dual edge mobile phone), according to an embodiment of the present disclosure;

FIG. 2 is a block diagram of an electronic device for managing data items, according to an embodiment of the present disclosure;

FIG. 3 is a block diagram of a processor, according to an embodiment of the present disclosure;

FIG. 4 is a flow chart illustrating a method for managing data items in which an action is performed to display at least one portion of GUI elements on an edge portion of an electronic device, according to an embodiment of the present disclosure;

FIG. 5 is a flow chart illustrating a method for managing data items in which a number of GUI elements is automatically flipped based on an input performed by a user, according to an embodiment of the present disclosure;

FIG. 6 illustrates an example scenario in which preview of a Notification window and a Message window available in a home page of a social networking service (SNS) application is displayed on an edge portion of an electronic device, according to an embodiment of the present disclosure;

FIGS. 7A and 7B illustrate example scenarios in which pages of an e-book are displayed on an edge portion of an electronic device, according to an embodiment of the present disclosure;

FIGS. 8A, 8B, 8C, and 8D show example scenarios in which various operations are performed to access information related to an email application, according to an embodiment of the present disclosure;

FIG. 9 illustrates an example scenario in which preview of background applications are displayed on an edge portion of an electronic device, according to an embodiment of the present disclosure;

FIGS. 10A, 10B, and 10C are example scenarios illustrating scroll effect, according to an embodiment of the present disclosure;

FIGS. 11A and 11B another example scenario illustrating scroll effect, according to an embodiment of the present disclosure;

FIG. 12A illustrates an example scenario in which a user applies light pressure on a right edge portion to automatically flip two pages of an e-book application, according to an embodiment of the present disclosure;

FIG. 12B illustrates an example scenario in which a user applies more pressure on a right edge portion to automatically flip 6 pages of an e-book application, according to an embodiment of the present disclosure;

FIG. 13 illustrates an example scenario in which a user performs a slide gesture over an edge portion to flip application pages with a page turn effect, according to an embodiment of the present disclosure;

FIG. 14 illustrates an example scenario in which a shadow of applications icons are displayed to a user when viewed through an edge portion of an electronic device, according to an embodiment of the present disclosure;

FIG. 15 illustrates a user's view for a tilted electronic device 100, according to an embodiment of the present disclosure;

FIGS. 16A and 16B illustrate the three dimensional (3D) abstraction of a user interface (UI), according to an embodiment of the present disclosure;

FIG. 17 shows details of the structure of a web page with an application depth framework, according to an embodiment of the present disclosure;

FIG. 18 shows application block diagram to incorporate an application depth framework for native applications, according to an embodiment of the present disclosure; and

FIG. 19 illustrates a computing environment implementing the method and electronic device for managing data items, according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Also, the various embodiments described herein are not necessarily mutually exclusive, as some embodiments can be combined with one or more other embodiments to form new embodiments.

Herein, the term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as units or modules or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and/or software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

Accordingly, embodiments herein provide a method for managing data items by an electronic device. The method includes determining at least one graphical user interface (GUI) element to be rendered on an edge portion of the electronic device. Further, the method includes causing to display a graphical data representation including the at least one GUI element on the edge portion of the electronic device, where the at least one GUI element is displayed at a depth level.

Another embodiment herein provides a method for managing data items by the electronic device. The method includes determining a plurality of GUI elements of the application to be rendered on the edge portion of the electronic device. Further, the method includes causing to display the graphical data representation including the plurality of GUI elements of the application on the edge portion of the electronic device, where the plurality of GUI elements is displayed at the depth level.

Unlike methods and systems of the related art, the proposed method provides a UI to use the edge portion of the electronic device to provide a three dimensional (3D) view of the running application (i.e., the application currently accessed by the user). Here, the running application is broken down into pages when viewed from the edge portion of the electronic device. Further, the edge portion provides additional useful information to the user.

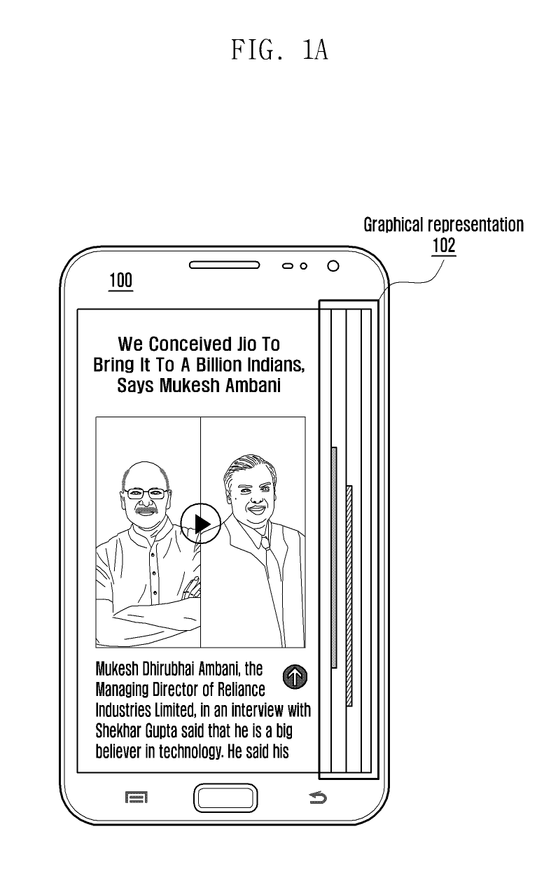

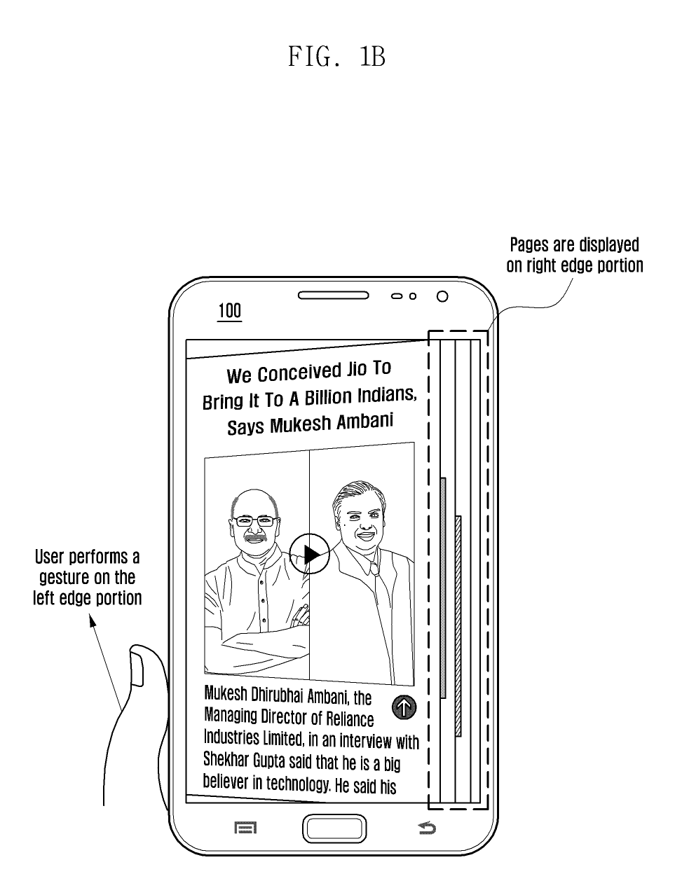

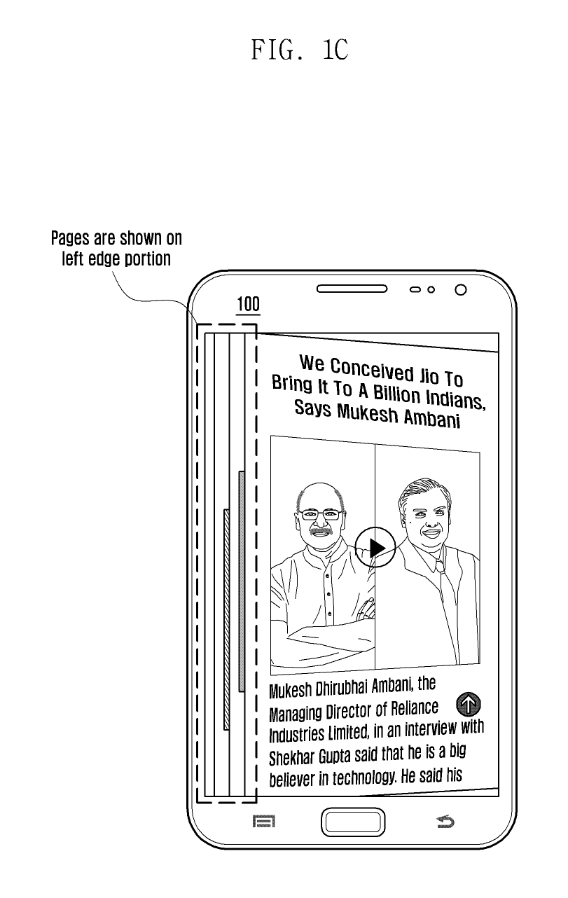

Referring now to the drawings, and more particularly to FIGS. 1A to 1C, 2, 3, 4, 5, 6, 7A and 7B, 8A to 8D, 9, 10A to 10C, 11A and 11B, 12A and 12B, 13, 14, 15, 16A and 16B, 17, 18, and 19, where similar reference characters denote corresponding features consistently throughout the figures, there are shown preferred embodiments.

FIGS. 1A to 1C illustrate example scenarios in which a graphical representation including content pages (i.e., GUI elements) of a news application are displayed on an edge portion (or an edge display portion) of an electronic device 100 (i.e., dual edge mobile phone), according to an embodiment of the present disclosure. Consider a scenario in which a user of the electronic device 100 accesses the news application including multiple sections (such as technology section, sports section, cinema section, etc.).

If it is determined that the multiple sections are available in the news application that are to be rendered as pages on the edge portion of the electronic device 100 then, a graphical representation including the pages are displayed on the edge portion of the electronic device 100 (i.e., each section in the news application is broken down/configured as a separate page and displayed as the GUI element) as shown in the FIG. 1A. In an example, the running application is broken down into pages when viewed from the edge portion of the electronic device 100. The graphical data representation is a 3D graphical data representation associated with a depth level. Further, as shown in the FIG. 1A, the main page of the news application is displayed on a screen of the electronic device 100. Each section of the news application is broken down into the page and displayed on the edge portion below the main application at the depth level. According to various embodiments, the electronic device 100 may display a plurality of GUI elements. In this case, a GUI element of higher level is displayed in a nearer area associated with the main display portion than a GUI element of lower level.

As shown in FIGS. 1B and 1C, the display of the electronic device 100 can include at least one edge. For example, an edge display portion can be included in each of the left and right sides of the main display portion. According to various embodiments, the GUI elements can be displayed on one of the first edge display portion of the left side and the second edge display portion of the right side. An edge display portion displaying the GUI elements may be determined based on a tilt direction of the electronic device 100 or selection by the user.

As shown in the FIG. 1B, the pages corresponding to multiple sections of the news application are displayed as a stack of pages on a right edge portion of the electronic device 100. Further, if the electronic device 100 is slightly tilted by the user then, the user can view the pages staggered on the right edge portion. As shown in the FIG. 1B, if the user performs a gesture (i.e., input) on a left edge portion of the electronic device 100 then, the stack of pages displayed on the right edge portion are shifted and displayed on the left edge portion as shown in the FIG. 1C. According to a different embodiment, an edge portion on which a stack of pages is displayed according to an inclination of the electronic device 100 may be changed. For example, if the left edge portion faces upwards as the user tilts the electronic device 100 to the right—i.e., the left edge portion gets close to the user's eye—the stack of pages may be displayed on the left edge portion. For example, when the user grips the left side of the electronic device 100 with a left hand, the stack of pages is displayed on the right edge portion. If the user grips the right side of the electronic device 100, the stack of pages is displayed on the left edge portion. In regard to this, a location of the user's grip on the electronic device 100 is determined by a touch screen of the display or a particular sensor positioned on a side of the electronic device 100.

According to various embodiments, the electronic device may change the content (i.e., application) on the main display portion based on whether the at least one GUI element is displayed on the first edge display portion or the second edge display portion. For example, as shown in FIG. 1B, if a GUI element is displayed on a right side, a page of a main screen may be displayed so that a vertical direction is longer on a right side and shorter on a left side, thereby displaying a book in a shape that is tilted to the left side. In addition, as shown in FIG. 1C, if the GUI element is displayed on a left side, the page of the main screen may be displayed so that the vertical direction is longer on a left side and shorter on a right side, thereby displaying the book in a shape that is tilted to the right side.

Unlike systems and methods of the related art, by using the proposed method, a 3D look and feel is provided to the user. Further, any application can paginate the content available in it and based on availability of a number of pages, the 3D look and feel can be provided to the user by displaying the pages on the edge portion by using an application depth framework.

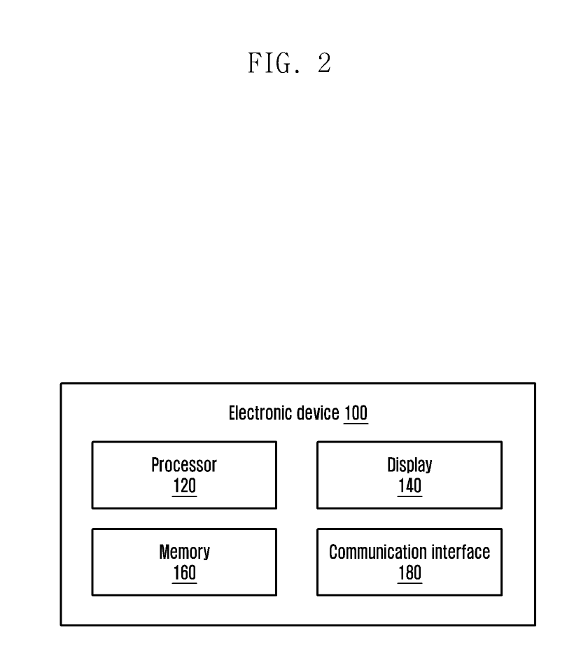

FIG. 2 is a block diagram of the electronic device 100 for managing data items, according to an embodiment of the present disclosure. In an embodiment, the electronic device 100 can be, for example, a laptop, a desktop computer, a mobile phone, a smart phone, personal digital assistants (PDAs), a tablet, a phablet, a consumer electronic device, a dual display device, a wearable device, or any other electronic device. The electronic device 100 includes a processor 120, a display 140, a memory 160, and a communication interface 180. The display 140 may include a touch screen. The processor 120 may include more than one processor 120. The display 140 can include a main display portion that displays, on a central area, general images of the electronic device, and at least one edge display portion positioned on a side of the main display portion (or an edge portion of the display 140). The display 140 may include an edge display portion on each of the left and right sides or include only one edge on one of the left and right sides. The edge display portion of the display 140 and the main display portion of the display be separate displays or collectively one display.

In an embodiment, the processor 120 can be configured to determine the GUI element(s) to be rendered on the edge portion of the electronic device 100. In an embodiment, the GUI elements are rendered on the edge portion along with the active GUI. The active GUI may be defined as content to be displayed on the main display portion. Each of the GUI elements is associated with the application and the active GUI is associated with the application. In an example, the GUI elements and the active GUI can be associated with same or different application. The application can be a, for example, messaging application, social networking site (SNS) application, email application, gallery application, call application, or any other application available in the electronic device 100. The active GUI may be displayed on a main display portion of the display 140.

Further, the processor 120 can be configured to control to display the graphical data representation 102 including the GUI elements on the edge portion of the electronic device 100. The graphical data representation 102 is a 3D graphical data representation associated with the depth level. In an embodiment, the GUI elements are displayed at the depth level below the active GUI. The user performs the input on the edge portion of the electronic device 100. The input can be the gesture such as, for example, a tap gesture, a swipe gesture, a long press gesture, a hover gesture, a press gesture, a flick gesture, or the like.

After detecting the input performed by the user, the processor 120 can be configured to perform an action to display at least one portion of the GUI elements on the display 140 of the electronic device 100. In an embodiment, the at least one portion of the GUI elements is displayed by transitioning the GUI elements. Each of the GUI elements includes an indicia indicating information about the corresponding GUI element. The GUI element of the application is a sub-GUI of the application, a sub-GUI of a state of the application, or a sub-GUI of a page of the application.

In another embodiment, the processor 120 can be configured to determine a plurality of GUI elements of the application to be rendered on the edge portion of the electronic device 100. The plurality of GUI elements is rendered along with the active GUI. Further, the processor 120 can be configured to control to display the graphical data representation 102 including the plurality of GUI elements of the application on the edge portion of the electronic device 100. The plurality of GUI elements is displayed at the depth level below the active GUI.

Further, the processor 120 can be configured to detect the input performed by the user on the edge portion of the electronic device 100. Further, the processor 120 can be configured to detect a level of resistance applied on the edge portion of the electronic device 100 based on the input. Further, the processor 120 can be configured to flip a number of GUI elements from the plurality of GUI elements based on the level of resistance. In an embodiment, the number of GUI elements is automatically flipped to display a GUI element available in the plurality of GUI elements after flipping the number of GUI elements.

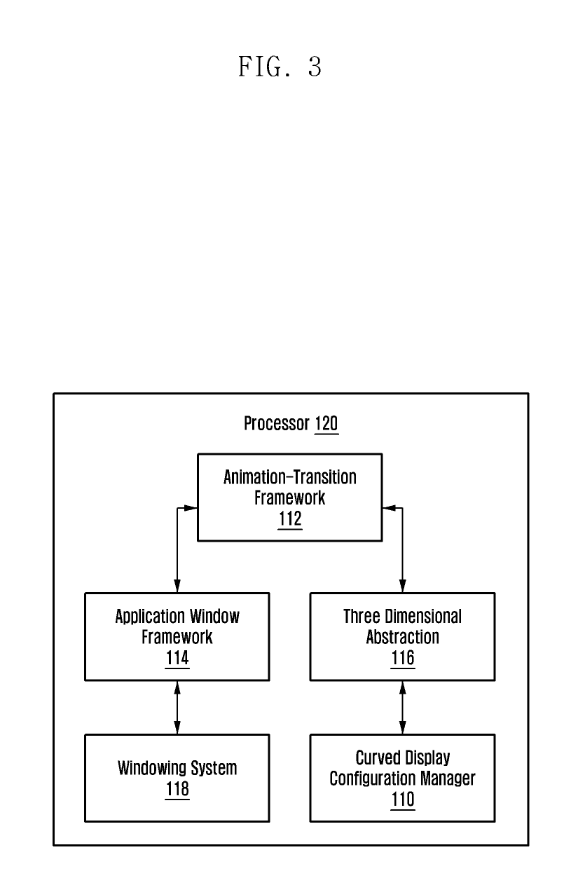

In another embodiment, the processor 120 can be configured to display a shadow of the GUI elements on the electronic device 100. Here, the GUI elements refer to application icons. The shadow includes an indicator indicating information about the corresponding GUI element. In an example, each application icon floats on the screen of the electronic device 100 and reflect the shadow of the application icon at the bottom of the main screen (i.e., below the main screen), viewed through the edge portion. Further, the shadow of each application icon represents information related to the application. In case of an email application, the shadow of the email application includes the indicator (i.e., a number) indicating a number of unread emails. Further, the functionalities of the processor 120 are explained in conjunction with FIG. 3.

The memory 160 may include one or more non-transitory computer-readable storage media. The memory 160 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 160 may, in some examples, be considered a non-transitory storage medium. The term “non-transitory” may indicate that the storage medium is not embodied in a carrier wave or a propagated signal. However, the term “non-transitory” should not be interpreted that the memory 160 is non-movable. In some examples, the memory 160 can be configured to store larger amounts of information than the memory. In certain examples, a non-transitory storage medium may store data that can, over time, change (e.g., in random access memory (RAM) or cache). The communication interface 180 communicates internally with the components and externally with networks.

In an embodiment, an application developer can select which application windows/options/tabs are to be displayed as separate pages on the edge portion. Here, the developer may select to display some application windows as such, while keeping the content of selected other application windows occluded or hidden (for example: bank account details, in a bank application). Once the user has successfully authenticated on a primary application window (i.e., a login page of the application), the entire content of the hidden windows is fully displayed and can be browsed through the edge portion of the electronic device 100.

In another embodiment, the user can configure which application windows to display as the separate pages. Here, the user can configure options (i.e., in settings of the application) as to which of the application windows should be displayed as the separate pages, and also the order of displaying the pages. In another embodiment, each of the tabs in the web browser application is displayed as the separate stacked page visible from the edge portion. In another embodiment, each section of the web page in the web browser (i.e., news, sports, etc.) is displayed as the separate stacked page visible from the edge portion.

The FIG. 2 shows a limited overview of the electronic device 100 but, it is to be understood that another embodiment is not limited thereto. Further, the electronic device 100 can include different components communicating among each other along with other hardware or software components. By way of illustration, both an application running on the electronic device 100 and the electronic device 100 can be the component.

FIG. 3 is a block diagram of the processor 120, according to an embodiment of the present disclosure. In an embodiment, the processor 120 includes an animation transition framework 112, an application window framework 114, a 3D abstraction 116, a windowing system 118, and a curved display configuration manager 110. The animation transition framework 112 can be configured to receive the input from the user. After receiving the input, the animation transition framework 112 can be configured to define animation of the application pages when viewed from the edge portion to a main screen of the electronic device 100.

The application window framework 114 takes care of managing the windows created pertaining to the application and paginating these windows in the order in which the application developer wants them to appear during the execution of the application. In an embodiment, the application developer may select which application windows are to be displayed as separate pages. For example, if an application has 3 windows, the application developer may select to number them as 1, 2, and 3 for the purpose of pagination. When the same application is displayed on the curved edge display portion using our 3D abstraction, the application windows 1, 2 and 3 are shown as separate pages which the user can view separately and manipulate. In an embodiment, the application developer may select to keep the content of certain application windows as occluded or hidden, for example where they contain confidential details, while fully showing the content of other windows. In another embodiment, the user rather than the application developer can configure which of the application windows they would select to be displayed as separate pages, as well as the order of their display.

In an embodiment, in case of a web browser application, each of the web browser tabs is shown as a separate stacked page visible from the edge display portion. In another embodiment, each of the sections of the webpage opened in the web browser (e.g. news, sports, business etc.) is shown as a separate stacked page visible from the edge display portion.

The 3D abstraction 116 can be configured to create a 3D view of any running application or the web page. Further, the curved display configuration manager 110 can be configured to manage the configuration of the edge portion. Further, the functionalities performed by the processor 120 are explained in conjunction with the FIG. 2.

The FIG. 3 shows a limited overview of the processor 120 but, it is to be understood that another embodiment is not limited thereto. Further, the processor 120 can include different components communicating among each other along with other hardware or software components. By way of illustration, both an application running on the processor 120 and the processor 120 can be the component.

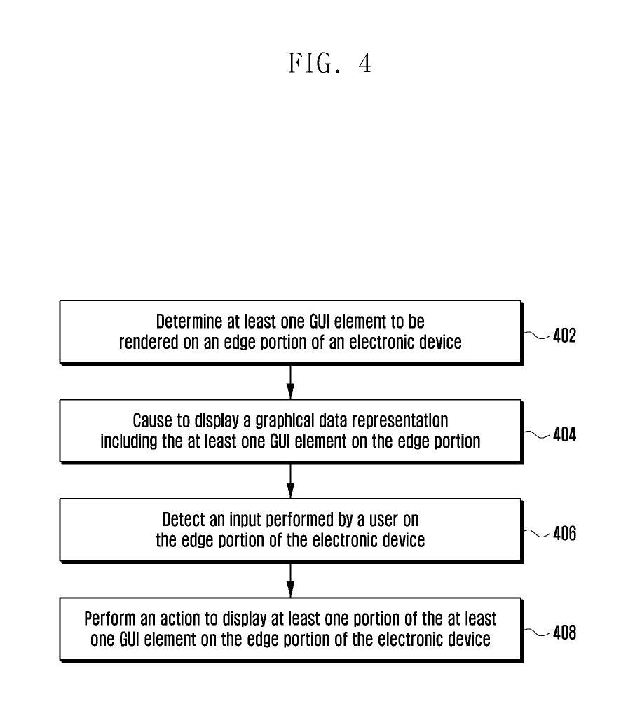

FIG. 4 is a flow chart illustrating a method for managing the data items in which the action is performed to display at least one portion of the GUI elements on the edge portion of the electronic device 100, according to an embodiment of the present disclosure. At operation 402, the method includes determining the GUI elements to be rendered on the edge portion of the electronic device 100. The method allows the processor 120 to determine the GUI elements to be rendered on the edge portion of the electronic device 100. In an example, the edge portion can be the left edge portion or the right edge portion of the electronic device 100.

In an embodiment, the GUI elements are rendered on the edge portion along with the active GUI. At operation 404, the method includes causing to display the graphical data representation 102 including the GUI elements on the edge portion of the electronic device 100. The method allows the processor 120 to control to display the graphical data representation 102 including the GUI elements on the edge portion of the electronic device 100. The GUI elements are displayed at the depth level below the active GUI. In an example, the GUI elements are displayed on the edge portion as the stack of pages, where each page corresponds to each of the GUI elements.

At operation 406, the method includes detecting the input performed by the user on the edge portion of the electronic device 100. The method allows the processor 120 to detect the input performed by the user on the edge portion of the electronic device 100. At operation 408, the method includes performing the action to display the at least one portion of the GUI elements on the screen of the electronic device 100. The method allows the processor 120 to perform the action to display (i.e., preview) the at least one portion of the GUI elements on the edge portion of the electronic device 100. In an example, the preview of the GUI elements is displayed on the edge portion (i.e., curved edge portion) based on the input performed by the user. In another example, the preview of the at least one portion of the GUI element is displayed on edge portion, wherein a size of the portion previewed depends on the level of resistance of the input performed by the user on the edge portion. In another example, a size of the portion previewed depends on at least one of a location of an input or duration of the input. In another example, the preview of the at least one portion of the GUI element is displayed on the main screen. In this case, the preview may be displayed in pop-up form on the active GUI of the main screen.

In another example, consider a scenario where the user accesses a history of a browser application. Most recent page accessed by the user is displayed on the screen of the electronic device 100 and rest of the pages accessed prior to the recent page are displayed as stack of pages on the edge portion of the electronic device 100 below the recently accessed page at the depth level. Here, the most recent page is considered as the active GUI.

The various actions, acts, blocks, operations, or the like in the flow chart shown in FIG. 4 may be performed in the order presented, in a different order or simultaneously. Further, in some embodiments, some of the actions, acts, blocks, operations, or the like may be omitted, added, modified, skipped, or the like without departing from the scope of the present disclosure.

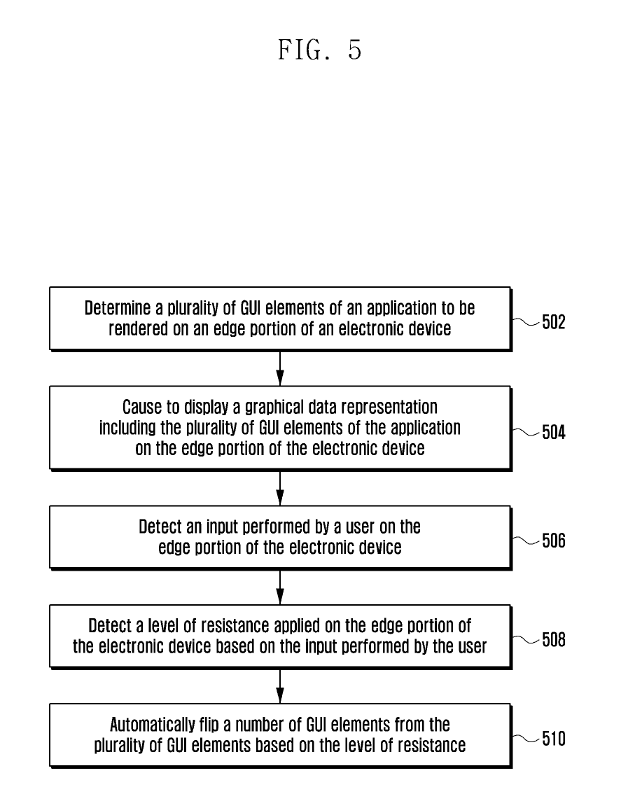

FIG. 5 is a flow chart illustrating a method for managing the data items in which the number of GUI elements is automatically flipped based on the input performed by the user, according to an embodiment of the present disclosure. At operation 502, the method includes determining the plurality of GUI elements of the application to be rendered on the edge portion of the electronic device 100. The method allows the processor 120 to determine the plurality of GUI elements of the application to be rendered on the edge portion of the electronic device 100.

At operation 504, the method includes causing to display the graphical data representation 102 including the plurality of GUI elements of the application on the edge portion of the electronic device 100. The method allows the processor 120 to control to display the graphical data representation 102 including the plurality of GUI elements of the application on the edge portion of the electronic device 100. The plurality of GUI elements is displayed at the depth level below the active GUI.

At operation 506, the method includes detecting the input performed by the user on the edge portion of the electronic device 100. The method allows the processor 120 to detect the input performed by the user on the edge portion of the electronic device 100. At operation 508, the method includes detecting the level of resistance applied on the edge portion of the electronic device 100 based on the input performed by the user. The method allows the processor 120 to detect the level of resistance applied on the edge portion of the electronic device 100 based on the input performed by the user.

At operation 510, the method includes automatically flipping the number of GUI elements from the plurality of GUI elements based on the level of resistance. The method allows the processor 120 to automatically flip the number of GUI elements from the plurality of GUI elements based on the level of resistance. In an example, based on the level of resistance (or amount of pressure) applied on the edge portion, less or more number of pages are flipped. If the user performs the input at rim of the edge portion then one page is flipped. If the user performs the input at middle of the edge portion then, 5 pages are flipped. Further, if the user performs the input at an end of the edge portion then, 10 pages is flipped. According to a different embodiment, the number of pages that are flipped may be determined according to a location of an input or duration of the input.

In an example, consider another scenario where the user opens multiple tabs in the browser application. The main page which is currently viewed by the user is considered as the active GUI and the multiple tabs in the browser application are displayed as the stack of pages on the edge portion of the electronic device 100 below the active GUI at the depth level.

The various actions, acts, blocks, operations, or the like in the flow chart shown in FIG. 5 may be performed in the order presented, in a different order or simultaneously. Further, in some embodiments, some of the actions, acts, blocks, operations, or the like may be omitted, added, modified, skipped, or the like without departing from the scope of the present disclosure.

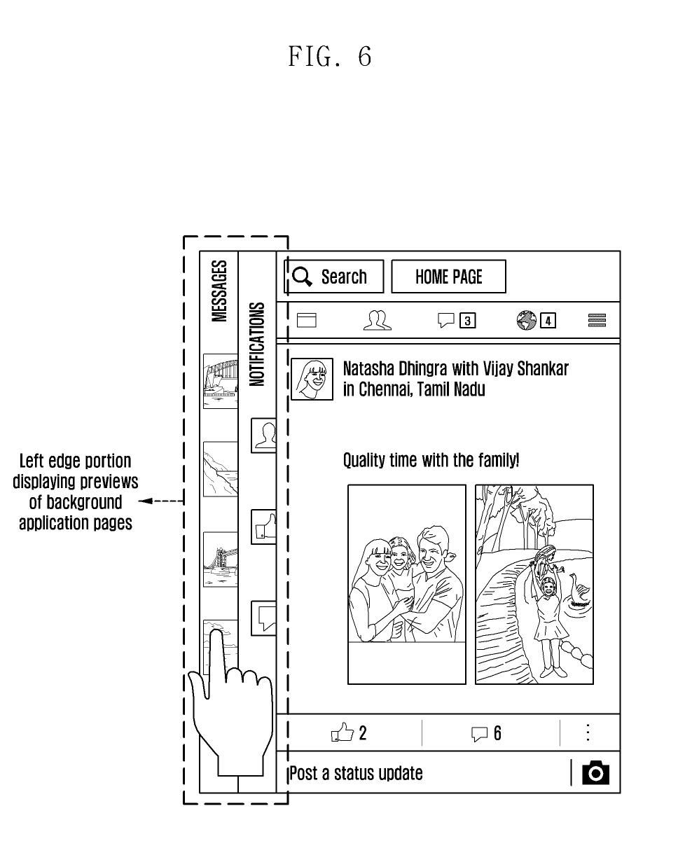

FIG. 6 illustrates an example scenario in which preview of a Notification window and a Message window available in a home page of the SNS application is displayed on the edge portion of the electronic device 100, according to an embodiment of the present disclosure. For example, initially, the application developer can design the application in terms of pages. The pages are displayed as the stacked pages on the edge portion of the electronic device 100. In case of the SNS application, the user can create the home page of the SNS application as a first page. The notification window available in the home page of the SNS application is created as a second page; and the Message window is created as a third page.

As shown in the FIG. 6, consider a scenario in which the user opens the SNS application and the home page of the SNS application is displayed on the screen of the electronic device 100. On opening the SNS application, the processor 120 determines that the Notification window and the Message window (i.e., GUI elements) are to be rendered on the edge portion. On determination, the processor 120 controls to display the graphical data representation including the Notification window and the Message window as the stack of pages on the edge portion below the home page of the SNS application. The Notification window and the Message window are displayed as the stack of pages on the edge portion at the depth level.

As shown in the FIG. 6, the Notification window is displayed as the separate page below the home page of the SNS application and the Message window is displayed as another separate page below the Notification window. The user can access any message or notification by performing the gesture. The user performs the gesture on the Notification window displayed on the edge portion to view a recent notification received by the user. After detecting the gesture, a portion of the notification is previewed on the edge portion and the content of the notification is displayed on the screen of the electronic device 100. The size of the preview portion depends on the level of resistance applied on the edge portion based on the gesture (i.e., slide gesture) performed by the user. According to a different embodiment, the content of the notification may be displayed in pop-up type on the main screen at the same time that the portion of the notification is previewed on the edge portion.

Unlike systems and methods of the related art, the user can preview the different options available in the application as the stack of pages on the edge portion and can able to directly navigate to a desired page by performing the input on the same.

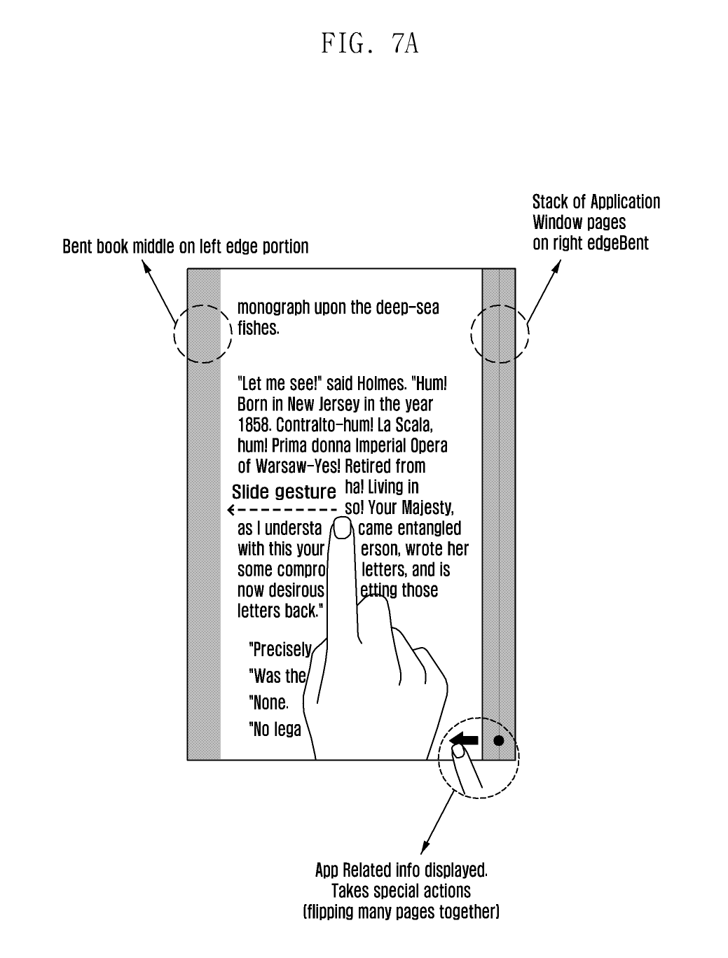

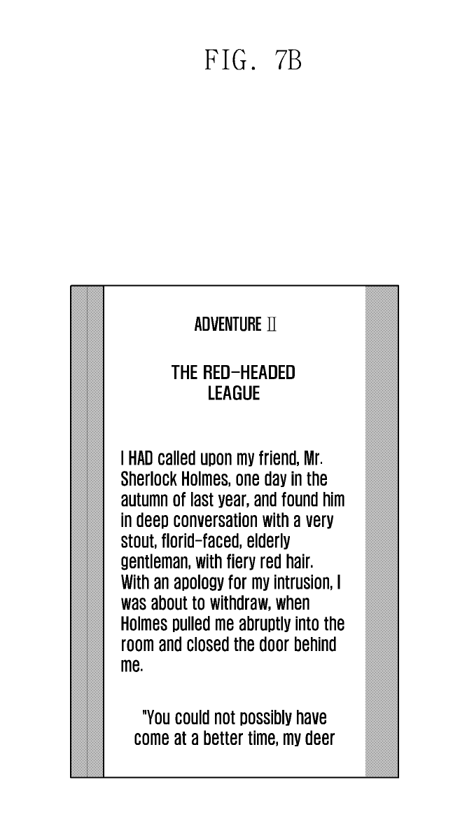

FIGS. 7A and 7B illustrate example scenarios in which pages of an e-book are displayed on the edge portion of the electronic device 100, according to an embodiment of the present disclosure. Consider a scenario where the user opens the e-book application available in the electronic device 100. As shown in the FIG. 7A, once the user opens the book, the processor 120 determines that the plurality of pages (i.e., plurality of GUI elements) of the e-book application is to be rendered on the edge portion.

After determining the plurality of pages, the processor 120 controls to display the graphical data representation 102 including the pages of the e-book on the edge portion, where the pages are displayed at the depth level below the main page (active GUI) of the e-book application. Here, each page is displayed on the edge portion at the depth level below the main page of the e-book application which is currently viewed by the user. As shown in the FIG. 7A, one end of the e-book displayed on the left edge portion looks like a bent book in middle and other end of the e-book displayed on the right edge portion looks like the stack of application window pages (or stack of pages).

Further, as shown in the FIG. 7A, the processor 120 detects the tap gesture performed by the user on the edge portion. Further, the processor 120 detects the level of resistance applied on the edge portion of the electronic device 100 based on the tap gesture performed by the user. Based on the level of resistance, the processor 120 automatically flips the number of pages from the plurality of pages.

Further, as shown in the FIG. 7A, the processor 120 detects the gesture performed by the user on the edge portion of the electronic device 100. The user performs the slide gesture from left side to right side on the screen of the electronic device 100 to the page of the e-book application. After determining the slide gesture, the processor 120 automatically flips the current page to display the next page on the screen of the electronic device 100 as shown in the FIG. 7B. The content of the next page is displayed on the screen as shown in the FIG. 7B.

According to various embodiments, the processor 120 may adjust the main screen so that an entire screen may be seen in three-dimensional form based on a position of the edge display portion on which the GUI element is displayed. For example, if the GUI element is displayed on the edge display portion of a right side, the page of the main screen may be displayed so that a vertical direction is longer on a right side and shorter on a left side, thereby displaying a book in a shape that is tilted to the left side. In this case, the active GUI of the main display portion and the GUI element of the edge display portion can provide a three-dimensional effect.

According to an embodiment, the processor 120 may render a plurality of GUI elements. In this case, a higher level GUI element may be displayed to be located on a higher layer than a layer of a lower level GUI element; or to be closer to the main body. For example, a subsequent page of a page displayed on the main display portion may be displayed in a nearest position to the main display portion from the edge display portion and next to a corresponding GUI element in accordance with a sequence of the page.

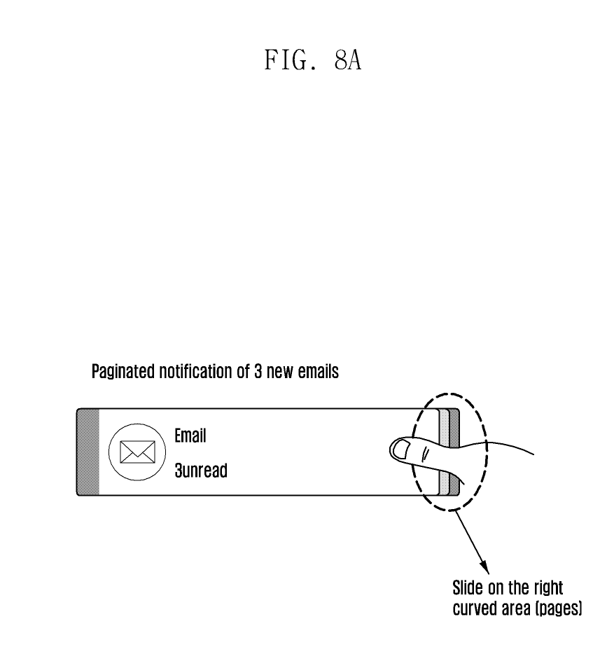

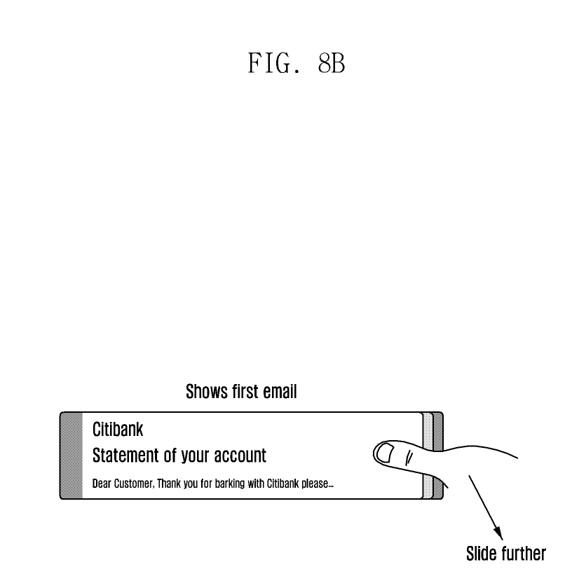

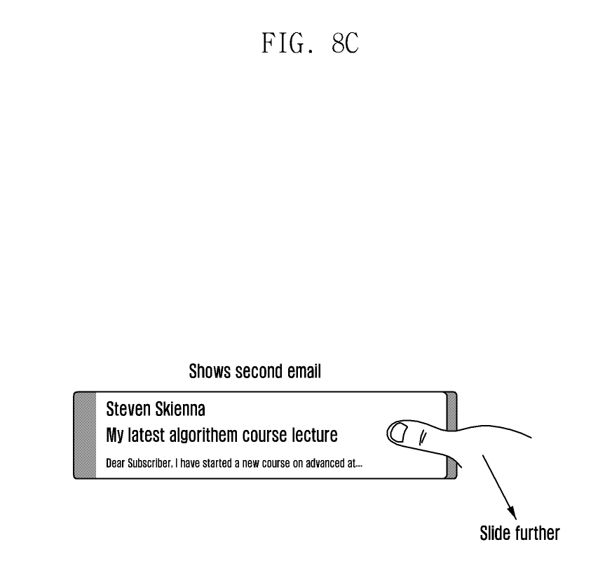

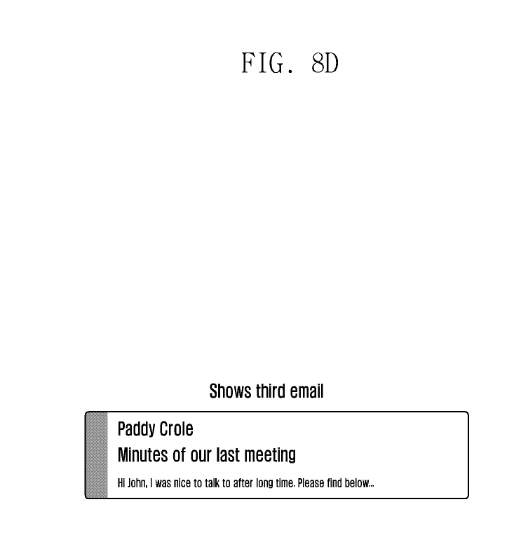

FIGS. 8A to 8D show example scenarios in which various operations are performed to access the information related to the email application, according to an embodiment of the present disclosure. Consider a scenario in which the user enables a lock screen of the electronic device 100. While the lock screen is enabled, the user receives three emails in the email application. The paginated notification of three emails are stacked as pages and displayed on the edge portion of the electronic device 100 as shown in the FIG. 8A.

Further, as shown in the FIG. 8A, the user performs the slide gesture (i.e., slide on the right curved area) to view the first email received by the user. The portion of the first email received by the user is displayed on the screen as shown in the FIG. 8B. The user again performs the slide gesture to view the second email. The portion of the second email is displayed on the screen as shown in the FIG. 8C. Further, the user once again performs the slide gesture to view the third email. The portion of the third email is displayed on the screen as shown in the FIG. 8C. Similarly, the user can slide the next emails and view it on the front of the display 140.

According to an embodiment, when the user touches a GUI element of the edge display portion, the preview of the GUI element may be displayed on the main display portion and/or edge display portion.

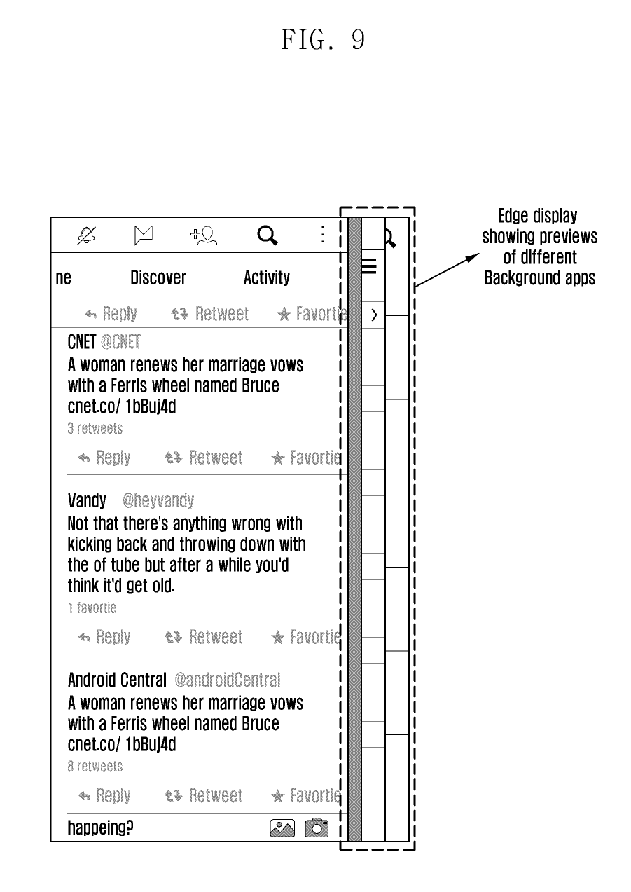

FIG. 9 illustrates an example scenario in which preview of background applications are displayed on the edge portion of the electronic device 100, according to an embodiment of the present disclosure. The background application may include a recently used application, an application of a high use frequency, or an application running currently in a background. In this scenario, the processor 120 determines that the background applications are to be rendered on the edge portion of the electronic device 100. After determining the background applications, the processor 120 displays the graphical data representation 102 including the GUI elements corresponding to the background applications on the edge portion of the electronic device 100. Each of the GUI elements corresponding to each background application is displayed at the depth level below the GUI element corresponding to the current application.

Further, as shown in the FIG. 9, the user can preview different background applications which are stacked as pages on the edge portion. Further, the user can perform the click gesture on the edge display portion to select any of the background application pages. Upon clicking, the selected application page comes to the foreground on the screen of the electronic device 100, while other applications go to the background.

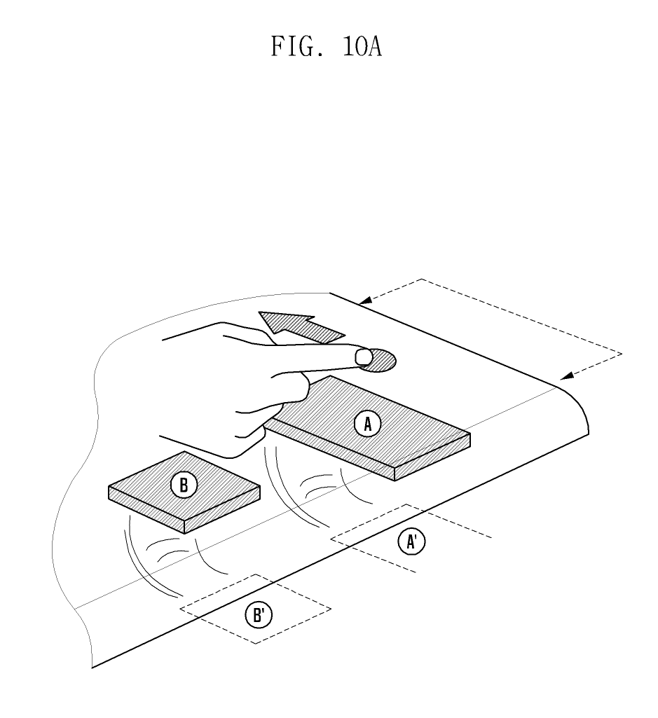

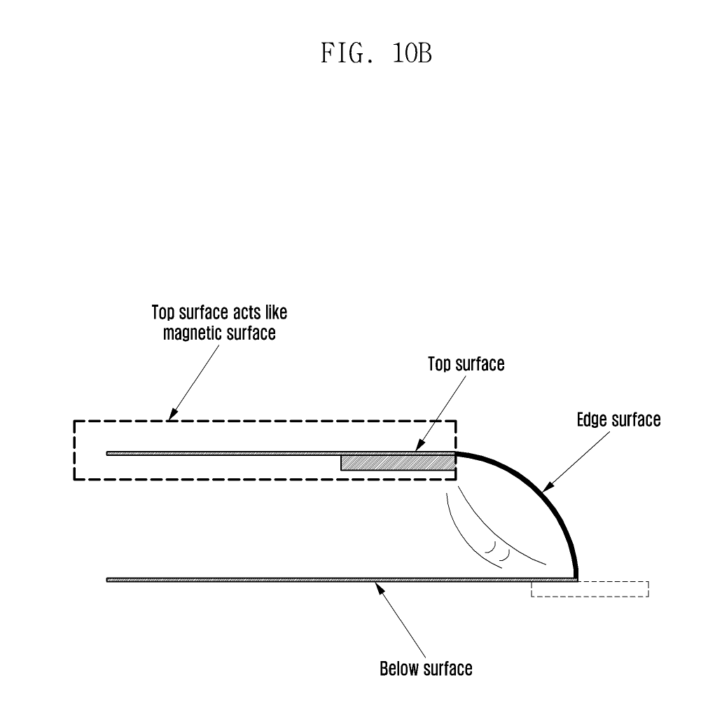

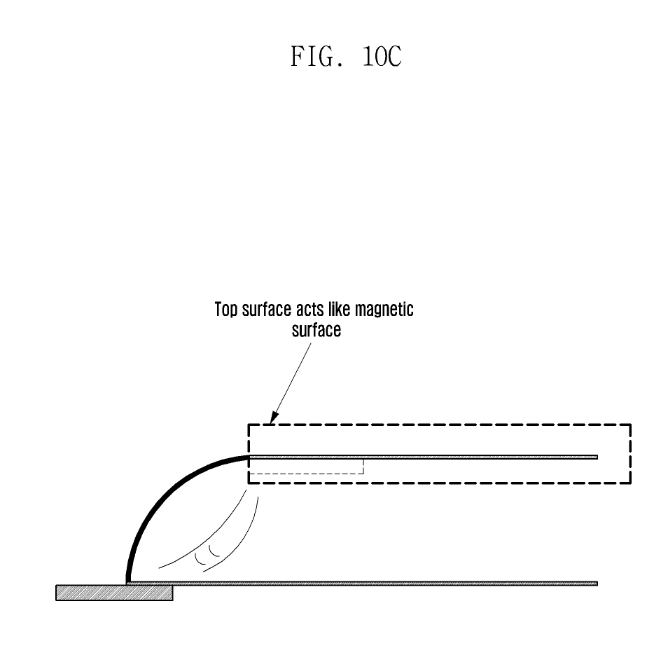

FIGS. 10A, 10B, and, 10C are example scenarios illustrating scroll effect, according to an embodiment of the present disclosure. Consider a scenario in which the user is currently viewing main menu showing different application icons. There may be other applications which are available in the electronic device 100 beyond the screen (i.e., available in next page of the main menu). In order to access the applications available in the next page, the user can perform the flick gesture from left side to the right side to accesses the applications. After detecting the flick gesture, the application icons available in the next page of the main menu are floated from bottom of the edge portion to the top of the edge portion.

As shown in the FIG. 10A, consider a scenario where the user is viewing the application icon A and the application icon B. Let the application icon A′ and the application icon B′ are falling in the next page of the main menu. The user performs the flick gesture from left side to the right side on the screen. After receiving the flick gesture, the application icon A′ and the application icon B′ floats from bottom of the edge portion to the top of the edge portion.

As shown in the FIG. 10B, the top surface acts like a magnetic surface, where the application icons can stick to it. Further, as shown in the FIG. 10C, after the application icons floating from the bottom edge portion to the top edge portion is completed, the application icons fall from the top surface to the below surface which are not shown to the user.

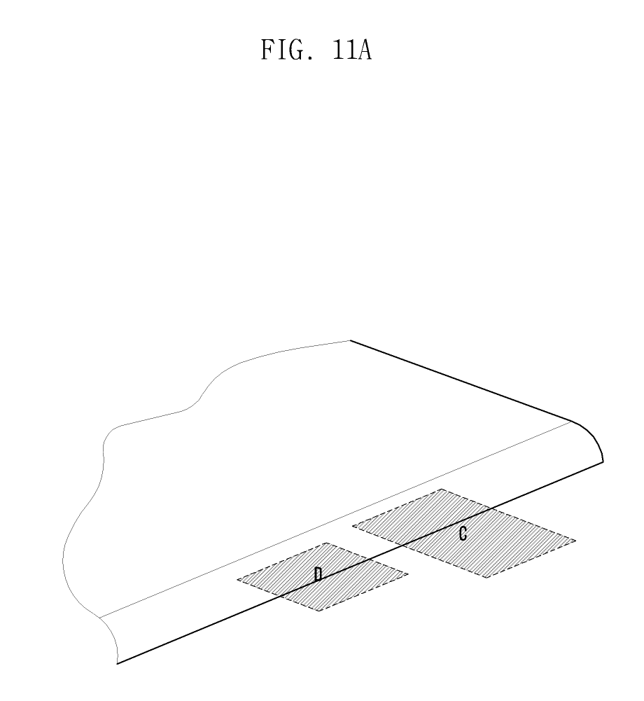

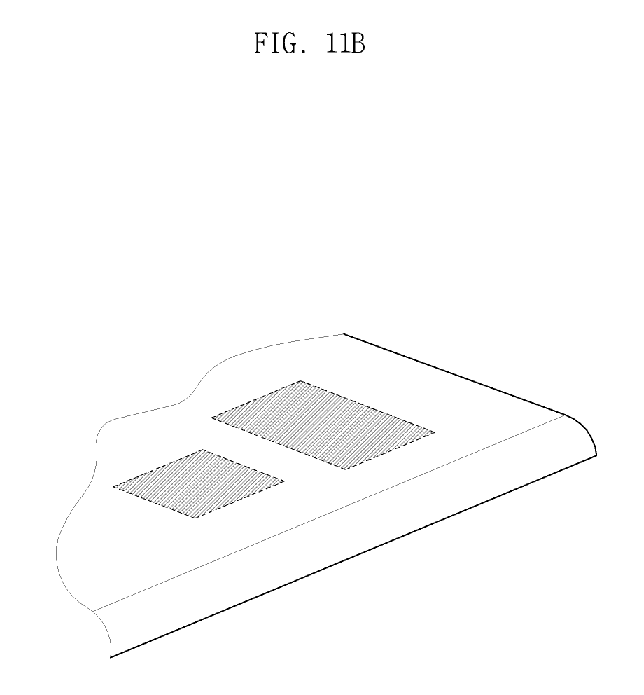

FIGS. 11A and 11B another example scenario illustrating the scroll effect, according to an embodiment of the present disclosure. Consider a scenario in which the user of the electronic device 100 scrolls the home screen (from right side to left side of the screen), the application icon C and the application icon D from the below surface as shown in the FIG. 11A gets attracted towards the top magnetic surface as shown in the FIG. 11B.

After reaching the top magnetic surface, the application icon C and the application icon D gets stuck on the top magnetic surface as shown in the FIG. 11B. Once the application icons reach the top magnetic surface, the application icon C and the application icon D continues to move towards the left side as the user continues to scroll until those applications moves out of the top magnetic surface and falls again to the below surface.

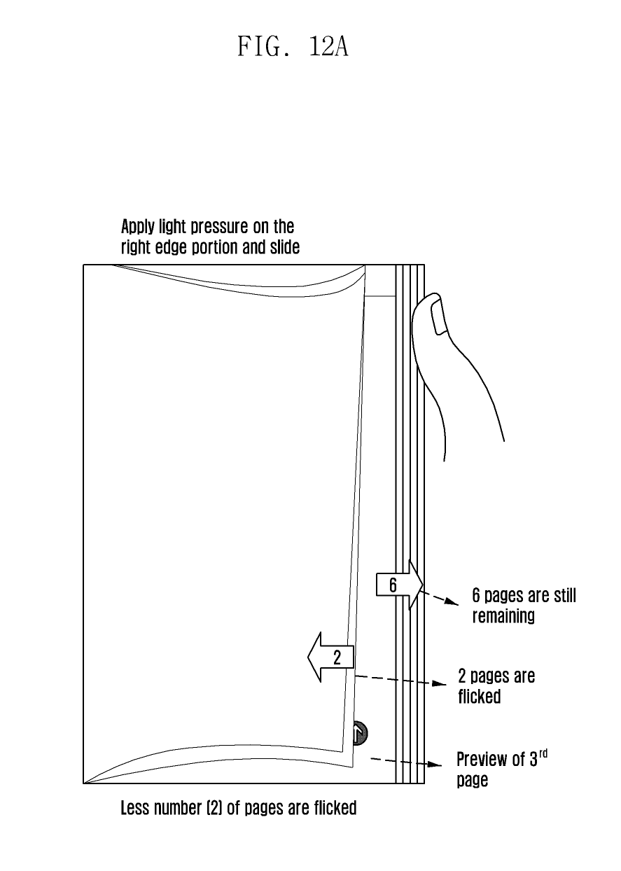

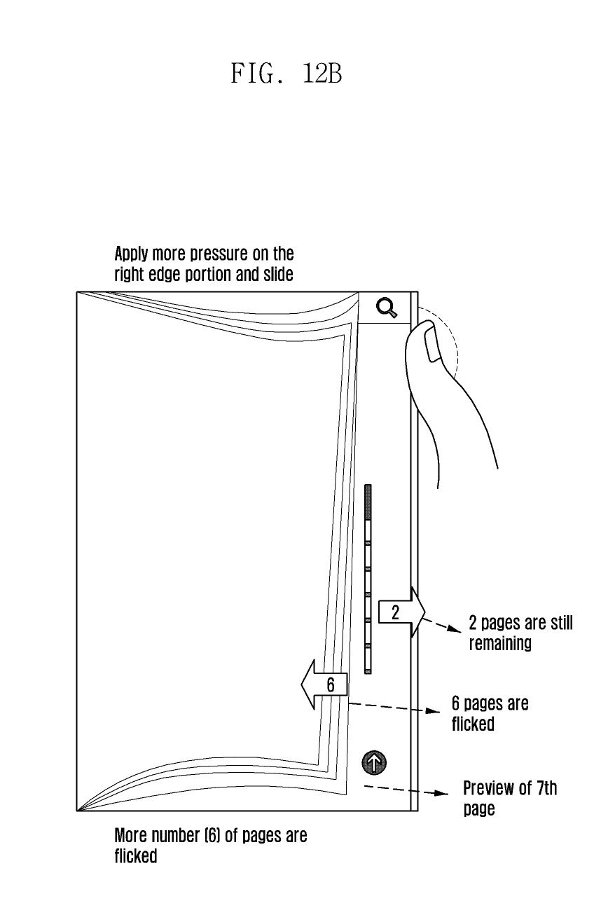

FIG. 12A illustrates an example scenario in which the user applies light pressure on the right edge portion to automatically flip two pages of the e-book application, according to an embodiment of the present disclosure. As shown in the FIG. 12A, the processor 120 displays the GUI elements corresponding to the plurality of pages of the e-book application on the edge portion of the electronic device 100. The plurality of pages is displayed at the depth level.

In this scenario, the user performs the gesture (i.e., applies light pressure) on the right portion. As the user has applied light pressure, only 2 pages from the total number of pages are automatically flipped as shown in the FIG. 12A. After flipping 2 pages, the preview of the third page is displayed on the screen of the electronic device 100. Further, as shown in the FIG. 12A, the user is provided with the indication that more 6 pages are remaining which are stacked as pages and displayed on the edge portion.

FIG. 12B illustrates an example scenario in which the user applies more pressure on the right edge portion to automatically flip 6 pages of the e-book application, according to an embodiment of the present disclosure. As shown in the FIG. 12B, the processor 120 displays the GUI elements corresponding to the plurality of pages of the e-book application on the edge portion of the electronic device 100. The plurality of pages is displayed at the depth level.

In this scenario, the user performs the gesture (i.e., applies more pressure) on the right portion. As the user applied more pressure, 6 pages from the total number of pages are automatically flipped as shown in the FIG. 12B. After flipping 6 pages, the preview of the seventh page is displayed on the screen of the electronic device 100. Further, as shown in the FIG. 12B, the user is provided with the indication that more 2 pages are remaining which are stacked as pages and displayed on the edge portion.

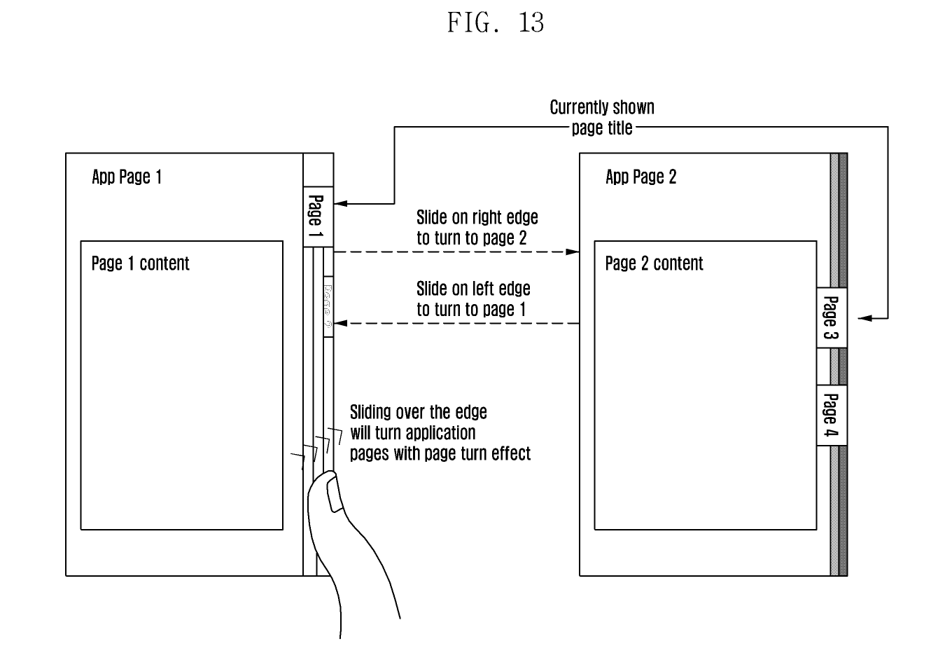

FIG. 13 illustrates an example scenario in which the user performs the slide gesture over the edge portion to flip the application pages with a page turn effect, according to an embodiment of the present disclosure. Initially, the user is displayed with the content of the page-1 on the screen of the electronic device 100 and rest of the pages is stacked below the page-1 at the depth level. By performing the slide gesture over the edge portion, the application pages are flipped/turned with the page turn effect.

The user can perform the slide gesture on the right edge portion to turn to page-2 from page-1. When the content of the page-2 is displayed on the screen of the electronic device 100, the user can perform the slide gesture on the left edge portion to accesses the page-1 which was previously flipped by the user.

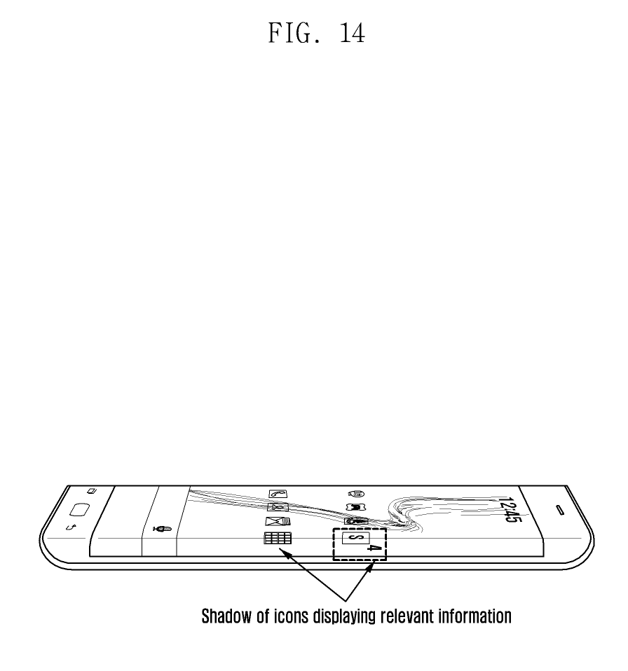

FIG. 14 illustrates an example scenario in which the shadow of the applications icons are displayed to the user when viewed through the edge portion of the electronic device 100, according to an embodiment of the present disclosure. As shown in the FIG. 14, the application icons float as if on water, and they leave the shadow at the bottom layer, when viewed through the edge portion.

Further, the shadow of each application icon represents useful information related to the application. Here, as shown in the FIG. 14, in case of an email application, the shadow includes the indicia indicating the number of unread emails.

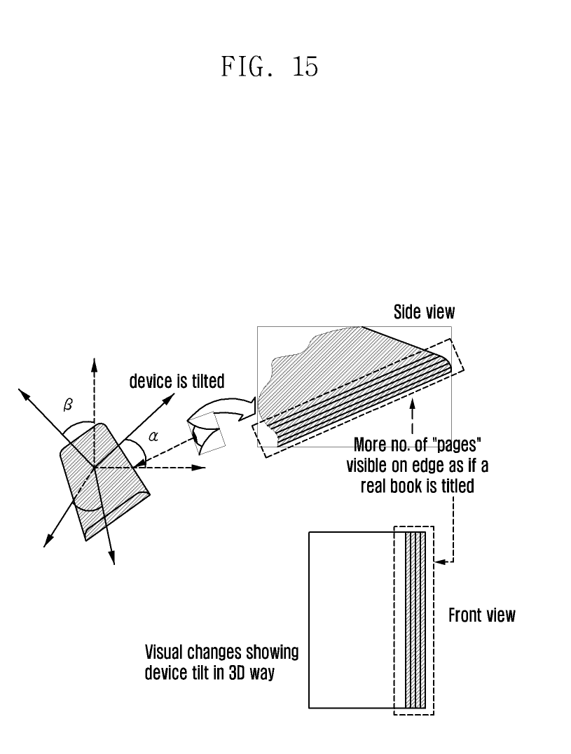

FIG. 15 illustrates a user's view for the tilted electronic device 100, according to an embodiment of the present disclosure. In an embodiment, (α, β, γ) represent the angles of tilt in the 3D sphere. The operations of the algorithm to calculate the edge transformation for the tilted device are indicated below:

EdgeTransformOnDeviceTilt(ϕ₀)//ϕ₀ is the initial device orientation

1. fᵢ(x, y, z) is the 3D surface currently displayed
//fᵢ(x, y, z) displayed the curved 3D surface with pages at the edge

2. R_{α, β, γ} is the transformation matrix
//R_{α, β, γ} transforms a surface f(x, y, z) to give a skewed presentation
//when the surface is subjected to a 3D rotation (α, β, γ)

3. User tilts the device with a 3D rotation ϕ(α, β, γ)
//3D rotation ϕ(α, β, γ) is measured using device orientation sensor data

4. S=GetCurrent3DEdgeGuiStructure( )
//Retrieve current edge GUI structure backend

5. S′=UpdatePaginatedDisplayApplyingTilt(S, ϕ₀, ϕ)
//Updates the content to be displayed based on the tilt. This updates//pages shown on one edge and depth effect on the other edge

6. f′=Prepare3DSurface(S′, fᵢ)
//Prepares the surface corresponding to updated content

7. f_{f}=R_{α, β, γ}(f′, ϕ)
//Apply on to get new skewed surface to be rendered

8. Render f_{f}

According to various embodiments, the electronic device may determine the displaying of a GUI element by considering a tilt. According to an embodiment, the processor may determine, based on a tilt direction of the electronic device, one of the two edge display portions on which to display the GUI element. In this case, the GUI element may be displayed on an edge display portion that is located comparatively higher. According to an embodiment, the processor may adjust an interval between GUI elements based on a tilt angle of the electronic device. For example, when the electronic device is close to parallel to the ground, the interval between the GUI elements may be adjusted to be narrower. When tilted further, the interval between the GUI elements may be adjusted to be wider. In addition, when the electronic device is close to parallel to the ground, an interval between GUI elements that are closer to the main display portion may be adjusted to be narrower and an interval between GUI elements that are father from the main display portion may be adjusted to be wider.

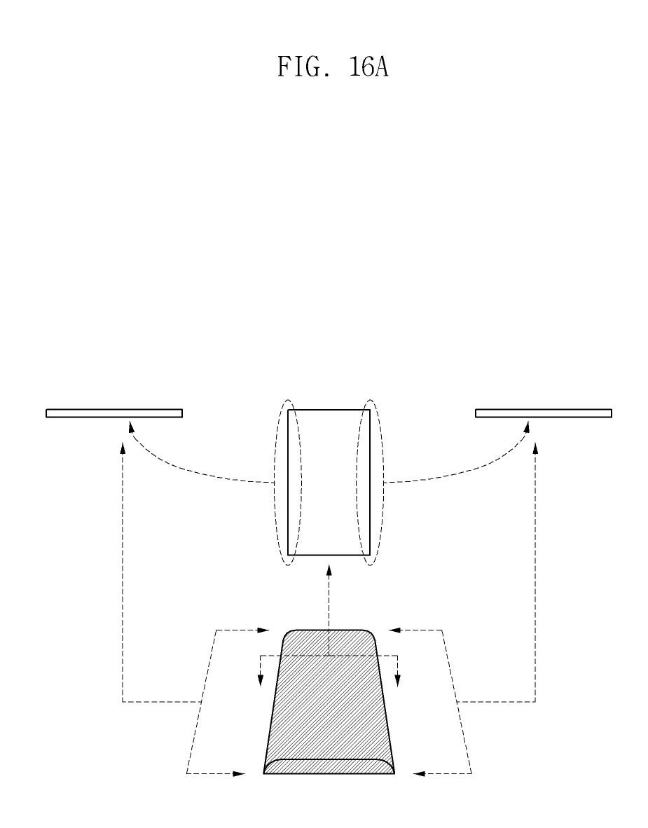

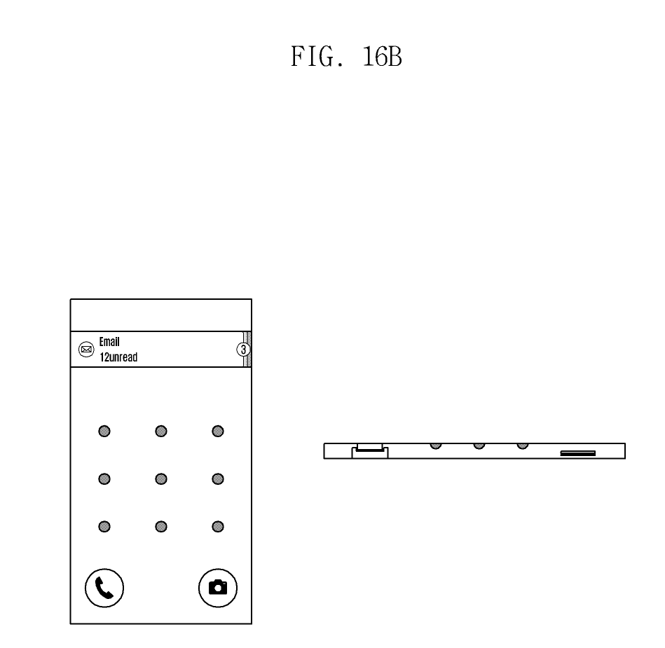

FIGS. 16A and 16B illustrate the 3D abstraction of the User Interface, according to an embodiment of the present disclosure. The FIG. 16A shows the views of the electronic device 100 from different viewing angles such as top view, left side view, and right side view. The FIG. 16B, for example, shows the side view (left side view/right side view) when the electronic device 100 is in locked state with the pattern lock displayed on screen along with the indication for new incoming emails.

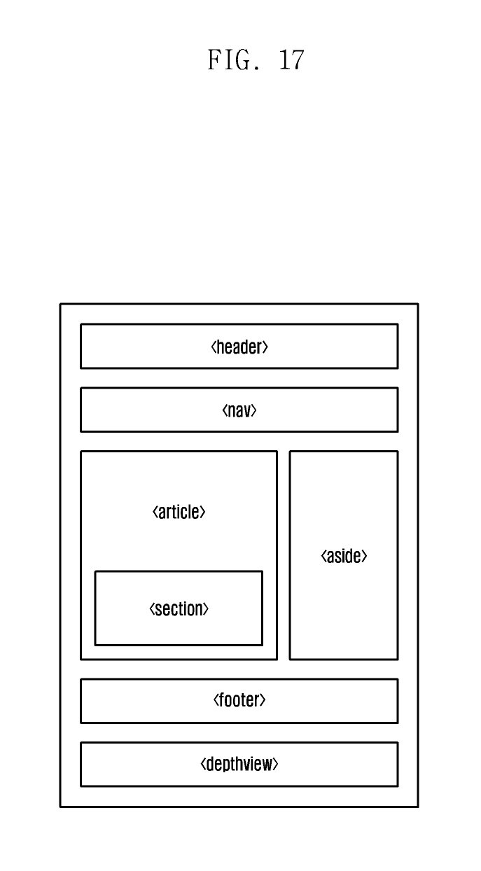

FIG. 17 shows details of the structure of the web page with the application depth framework, according to an embodiment of the present disclosure. A new part ‘depthview’ is added to a HTML standard page structure. This new part can be programmed by the content developer or set by the user when the depth view for the page is shown on the edge display portion for at least one of:

a. The content to be displayed;

b. The kind of display it should have when shown on the edge;

c. The effects to be shown (‘float’, ‘shadow’ etc.); or

d. The user interactions (‘flick’, ‘press’ etc.).

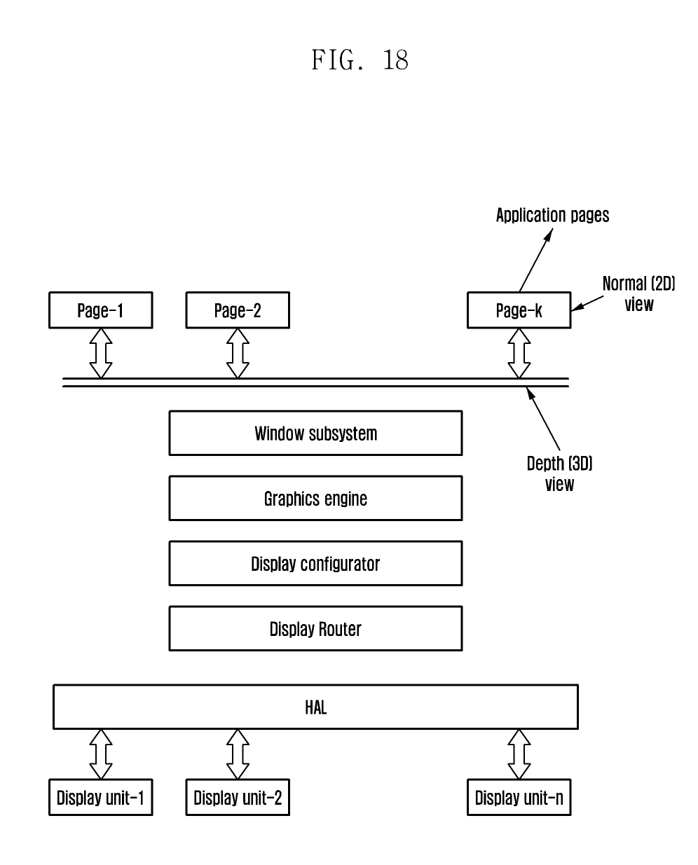

FIG. 18 shows a block diagram to incorporate the application depth framework for native applications, according to an embodiment of the present disclosure. A new component called Depth 3D view is added to work along with the standard two dimensional (2D) view in the native applications. This new part can be programmed by the content developer or set by the user when the depth view for the application page is shown on the edge display portion.

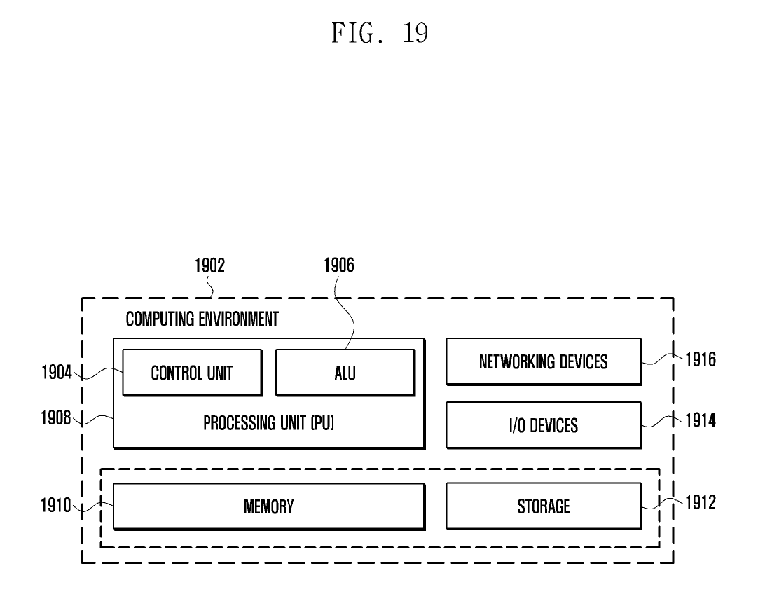

FIG. 19 illustrates a computing environment 1902 implementing the method and electronic device 100 for managing the data items, according to an embodiment of the present disclosure. As depicted in the figure, the computing environment 1902 comprises at least one processing unit 1908 that is equipped with a control unit 1904 and an arithmetic logic unit (ALU) 1906, a memory 1910, a storage 1912, plurality of networking devices 1916, and a plurality input/output (I/O) devices 1914. The processing unit 1908 is responsible for processing the instructions of the schemes. The processing unit 1908 receives commands from the control unit 1904 in order to perform its processing. Further, any logical and arithmetic operations involved in the execution of the instructions are computed with the help of the ALU 1906.

The overall computing environment 1902 can be composed of multiple homogeneous or heterogeneous cores, multiple central processing units (CPUs) of different kinds, special media and other accelerators. The processing unit 1908 is responsible for processing the instructions of the schemes. Further, the plurality of processing units 1908 may be located on a single chip or over multiple chips.

The scheme comprising of instructions and codes used for the implementation are stored in either the memory 1910 or the storage 1912 or both. At the time of execution, the instructions may be fetched from the corresponding memory 1910 or storage 1912, and executed by the processing unit 1908.

In case of any hardware implementations various networking devices 1916 or external I/O devices 1914 may be connected to the computing environment to support the implementation through the networking devices and the I/O devices.

The embodiments disclosed herein can be implemented through at least one software program running on at least one hardware device and performing network management functions to control the elements. The elements shown in the FIGS. 1A through 19 include blocks which can be at least one of a hardware device, or a combination of hardware device and software units.

The foregoing description of the specific embodiments will so fully reveal the general nature of the embodiments herein that others can, by applying current knowledge, readily modify or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

The embodiments disclosed herein can be implemented through at least one software program running on at least one hardware device and performing network management functions to control the elements.

While the present disclosure has been shown and described with reference to various embodiments thereof, it will be understood by those skilled in the art that various changes in form and details may be made therein without departing from the spirit and scope of the present disclosure as defined by the appended claims and their equivalents.

1. An electronic device comprising:
a display comprising a touch screen, the display including a main display portion and at least one edge display portion; and
at least one processor configured to:
control the display to display a content on the main display portion;
determine at least one graphical user interface (GUI) element in associated with the content to be rendered on the at least one edge display portion; and
control the display to display the at least one GUI element on the at least one edge display portion,
wherein the at least one GUI element is displayed at a depth level.

2. The electronic device of claim 1, wherein the at least one processor is configured to control the display to display the at least one GUI element as a stacked shape.

3. The electronic device of claim 2, wherein a GUI element of a higher level is displayed closer to the main display portion than a GUI element of lower level.

4. The electronic device of claim 1,
wherein the content includes multiple pages, and
wherein the at least one processor is configured to control the display to display one of the multiple pages on the main display portion and display parts of another of the multiple pages on the edge display portion.

5. The electronic device of claim 1, wherein the at least one processor is configured to control the display to display an application executed in a foreground on the main display portion and display a part of at least one application executed in a background on the edge display portion.

6. The electronic device of claim 1, wherein the at least one GUI element includes an indicator indicating information corresponding to the GUI element.

7. The electronic device of claim 1, wherein, when a touch input for selecting the GUI element is detected by the touch screen, the at least one processor is configured to control the display to display a preview of the GUI element along with the GUI element on the edge display portion or as a pop-up screen on the main display portion.

8. The electronic device of claim 1, wherein, when a touch input for selecting the GUI element is detected by the touch screen, the at least one processor is configured to control the display to display the GUI element on the main display portion instead of the content.

9. The electronic device of claim 1,
wherein the at least one edge display includes a first edge display portion positioned on a left edge area of the display and a second edge display portion positioned on a right edge area of the display, and
wherein the at least one processor is configured to control the display to display the at least one GUI on one of the first edge display portion or the second edge display portion, based on inclination of the electronic device.

10. The electronic device of claim 9, wherein the at least one processor is configured to determine an interval between the at least one GUI element based on an angle of the inclination of the electronic device.

11. The electronic device of claim 9, wherein the at least one processor is configured to change the content displayed on the main display portion based on whether the at least one GUI element is displayed on the first edge display portion or the second edge display portion.

12. A method for displaying at least one graphical user interface (GUI) element on a display including a main display portion and at least one edge display portion, the method comprising:
displaying a content on the main display portion;
determining at least one GUI element in associated with the content to be rendered on the at least one edge display portion; and
displaying the at least one GUI element on the at least one edge display portion,
wherein the at least one GUI element is displayed at a depth level.

13. The method of claim 12, wherein displaying of the at least one GUI element comprises displaying the at least one GUI element as a stacked shape.

14. The method of claim 13, wherein a GUI element of higher level is displayed closer to the main display portion than a GUI element of lower level.

15. The method of claim 12,
wherein the content includes multiple pages, and
wherein one of the multiple pages is displayed on the main display portion and parts of another of the multiple pages are displayed on the edge display portion.

16. The method of claim 12, wherein an application executed in a foreground is displayed on the main display portion and a part of at least one application executed in a background is displayed on the edge display portion.

17. The method of claim 12, further comprising:
detecting a touch input for selecting the GUI element; and
displaying a preview of the GUI element along with the GUI element on the edge display portion or as a pop-up screen on the main display portion.

18. The method of claim 12, further comprising:
detecting a touch input for selecting the GUI element; and
displaying the GUI element on the main display portion instead of the content.

19. The method of claim 12,
wherein the at least one edge display includes a first edge display portion positioned on a left edge area of the display and a second edge display portion positioned on a right edge area of the display, and
wherein the displaying of the at least one GUI element comprises displaying the at least one GUI on one of the first edge display portion or the second edge display portion, based on inclination of the electronic device.

20. The method of claim 19, further comprising changing the content on the main display portion based on whether the at least one GUI element is displayed on the first edge display portion or the second edge display portion.
